(19) United States
(12) Patent Application Publication
(10) Pub. No.: US 2024/0380308 A1
(43) Pub. Date: Nov. 14, 2024

(54) CONSTANT CURRENT CIRCUIT DRIVER

(71) Applicant: Ademco Inc., Golden Valley, MN (US)

(72) Inventor: Jesus Omar Ponce, Chihuahua (MX)

(73) Assignee: Ademco Inc., Golden Valley, MN (US)

(21) Appl. No.: 18/656,910

(22) Filed: May 7, 2024

Related U.S. Application Data
(60) Provisional application No. 63/501,002, filed on May 9, 2023.

(51) Int. Cl. H02M 1/32; H02M 7/06

(52) U.S. Cl. CPC H02M 1/32; H02M 7/06

(57) ABSTRACT

Disclosed is an electrical circuit that includes an input terminal configured to receive a power signal as input; a rectifier bridge configured to receive the power signal from the input terminal; a resistive load connected between the input terminal and the rectifier bridge, the resistive load configured to control the current of the power signal to the rectifier bridge; a current limiter circuit configured to receive a constant current from the rectifier bridge; and an output terminal configured to provide an output power signal based on the constant current flowing through the current limiter circuit.

### CROSS-REFERENCE TO RELATED APPLICATIONS

This application claims the benefit of and priority to U.S. Provisional Patent Application No. 63/501,002, filed on May 9, 2023, the contents of which are incorporated herein by reference.

### FIELD OF TECHNOLOGY

The present disclosure generally relates to a constant current circuit capable of generating leakage current and methods of use thereof.

### BACKGROUND OF TECHNOLOGY

A line voltage circuit is an electrical current that carries high voltage alternating current (“AC”) power from a power source to an electrical load, such as appliances or computing devices. Current configurations, however, result in varying or unknown leakage currents, which can impact how reliant systems and/or circuits operate.

### SUMMARY OF DESCRIBED SUBJECT MATTER

Typically, line volt circuits that utilize a ground fault circuit interrupter (“GFCI”) protection require a circuit for automatic testing. Underwriters Laboratories (UL) and Canadian Standards Association (“CSA”) are the two entities that require these protections for line volt circuits. One type of conventional testing method for electrical circuits involves automatically applying a series of test signals to the circuit and measuring a resulting response. Another type of automatic testing method for electrical circuits involves measuring the resistance of the circuit using a bridge circuit to detect faults in the circuit, which can include, for example, open circuits, short circuits, or high resistance connections.

GFCI protection features can be usually performed by momentarily connecting a fixed value resistor (R_{B}), which may represent an alternative resistance bridge, in the current path to be sensed, so a leakage current can be created. The fixed value resistor may refer to an electrical component that provides a fixed amount of resistance to the flow of electrical current in a circuit determined at the time of manufacture and cannot be changed by the user.

A leakage current is the small amount of current that flows through a device or material even when it is supposed to be non-conductive or in a non-operating state. The current value of the leakage current can depend on the level on the line voltage supplying the device (“Line”)—for example, the device can be a thermostat. As such, a result may be dependent of line voltage fluctuations, which are variations in the voltage level of the electrical power grid that supplies electricity to the device. Leakage current values can be represented as follows: V_{Line}/R_{B}.

For example, if the device (e.g., thermostat, for example) performs an automatic test when there is a low voltage in the line voltage, the test will fail since the leakage current will not be enough to trip the current sense circuit. A current sense circuit may refer to an electronic circuit that is used to measure the current flowing through a circuit or a load by measuring the voltage drop across a sensing element that is inserted in series with the load, such as a resistor or a current transformer. As a result of the test failure, abnormal behaviors of the device can occur. In other words, unreconciled leakage currents may lead to device failure and/or unexpected results, which can cause harm to the device, a system, property and/or human beings.

Accordingly, as provided in the instant disclosure, the disclosed circuit configurations provide a constant current circuit that maintains a steady current flow through a load, regardless of changes in the load resistance or other external factors. Thus, the constant current circuit can cause the an automatic generated leakage current to remains constant, independent of the supplied line voltage. By this, the leakage current is ensured to be fixed even if the automatic testing is performed during a line perturbation event.

### BRIEF DESCRIPTION OF DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of an exemplary circuit maintaining a constant current with at least one optional constant current, in accordance with one or more embodiments of the present disclosure.

FIG. 2 depicts a waveform diagram associated with the optional constant current within the exemplary circuit, in accordance with one or more embodiments of the present disclosure.

FIG. 3 depicts a waveform diagram associated with the constant current within the exemplary circuit, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

Embodiments of the present disclosure provide at least one exemplary technical solution to the previously stated exemplary technical problem associated with the utilization of an automatically generated leakage current within a constant current circuit. In some embodiments, the present disclosure provides a constant current circuit utilizing the automatically generated leakage current will be constant and independent of the supplied vine voltage. The automatically generated leakage current may ensure that the leakage current will be fixed even if the automatic testing is performed during a line perturbation event. The line perturbation event may refer to a sudden change in the voltage or current levels that occur along the circuit line that can cause a temporary disturbance in the output of the constant current circuit. For example, the line perturbation event may refer to sudden changes in load, changes in input voltage, and/or electromagnetic interference.

In some embodiments, a rectifier bridge may be used to ensure on direct current (“DC”) is supplying the current limiter circuit. In some embodiments, a metal-oxide-semiconductor field-effect transistor (“MOSFET”) is a type of transistor used in electronic circuits for switching and amplification purposes. In some embodiments, the MOSFET has three terminals: a gate, a source, and a drain and works by controlling the flow of current between the source and drain terminals by applying a voltage to the gate terminal and the voltage applied to the gate terminal creates an electric field in the transistor's channel, which can either allow or block the flow of current. In some embodiments, the MOSFET may refer to a constant current source. In some embodiments, a bipolar junction transistor (“BJT”) may be utilized as a cutoff switch that will adjust the MOSFET to act as a constant current driver by biasing the transistor in such a way that it operates in the cutoff region, where the transistor is turned off and acts as an open circuit that prevents current flow through it. In some embodiments, the constant current driver may refer to an electronic circuit that regulates the flow of current through a load and maintain a constant current output despite variations in the load resistance, input voltage, or other factors.

In some embodiments, the rectifier bridge may refer to a bias resistor for the MOSFET and the BJT. In some embodiments, the bias resistor may refer to a resistor that is used in electronic circuits to set the operating point of a transistor or other active device and is typically connected to the base or gate of the transistor and sets the voltage level at that point, which determines the amount of current flowing through the transistor. In some embodiments, a set current resistor may configure the desired current level using at least one enable transistor. In some embodiments, the enable transistor may refer to a type of transistor that is used to control the flow of current in an electronic circuit used in digital circuits to enable or disable a specific function or signal path. In some embodiments, the constant current circuit may control the current flowing the an optional load and control the current sink from a power supply for at least one specific purpose. In some embodiments, the at least one specific purpose may refer to a test performed on a leakage current.

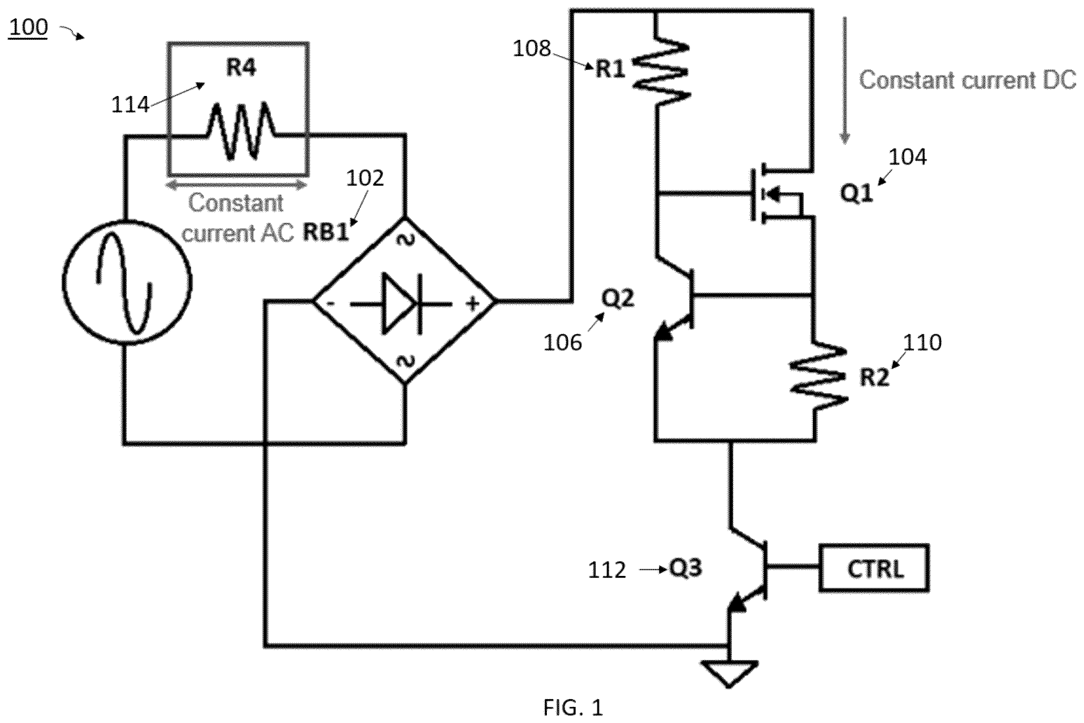

FIG. 1 depicts a block diagram of an exemplary circuit maintaining a constant current with at least one optional constant current, in accordance with one or more embodiments.

In FIG. 1, a rectifier bridge, referred to as RB1 102, is used to ensure only direct current is supplying the current limiter circuit within a constant current circuit 100. Q1 104 is a MOSFET used as a constant current source for the constant current circuit 100, while Q2 106 is a BJT used as a cut off switch that will adjust Q1 104 to act as a constant current driver associated with the constant current circuit 100. R1 108 is a bias resistor for Q1 104 and Q2 106. R2 110 is a set current resistor utilized to configure the desired current level of the constant current circuit 100. Q3 112 is an enable transistor of the constant current circuit. In some embodiments, an optional load R4 114 may connect an energy source and the input of the rectifier bridge.

In some embodiments, an input terminal associated with the constant current circuit 100 may receive at least one power signal as input.

In some embodiments, a plurality of components are selected in a predetermined order to ensure the automatic generation of leakage current. In some embodiments, the RB1 102, Q1 104, Q2 106, and Q3 112 may be selected to support at least twice a desired operating current value and twice the maximum input leak voltage. In some embodiments, the desired operating current value may refer to a typical amount of current that a device or system requires to operate properly. In some embodiments, the maximum input leak voltage may refer to the highest voltage that can be-applied to the input of a device or system without causing excessive leakage current.

In some embodiments, R1 108 may be selected with a high value to avoid the bias current being a significant part of the leakage current, while simultaneously being low enough to allow for a predetermined level of operation of the plurality of selected transistors. In some embodiments, the bias current may refer to a steady current that flows through a device even when no input signal is present and may be a small, constant current that is utilized to establish an operating point of the device.

In some embodiments, R2 110 may be selected to support power dissipation for a desired operation current. In some embodiments, the power dissipation may refer to a process that converts electrical energy into heat energy within a device, and this occurs in response to current flowing through the device where resistance to the flow of the current causes some electrical energy to be converted to heat energy. For example, R2 110 may utilize the following equation to support the power dissipation for the desired operation current: P=I^{2x}R, where P refers to power in watts, I refers to the current measured in amperes, and R refers to the resistance in ohms.

In some embodiments, a calculation of the peak current of an application is utilized to select an appropriate R2 110 value. In some embodiments, the peak current may depend on a plurality of factors, such as the circuit topology, the waveform of the input signal, the impedance of the load, and the characteristics of the component used in the circuit. For example, when sinusoidal alternate current is utilized, an ideal approximation may refer to a multiplication of the desired operating current by a predetermined value of 1.4142. In some embodiments, the sinusoidal AC current may refer to a voltage that varies in magnitude and direction over time associated with a sinusoidal waveform. In some embodiments, a voltage between base and emitter (“VBE”) associated with Q2 106 may be divided by the peak current associated with R2 110 to obtain the appropriate R2 110 value.

In some embodiments, the Q3 112 must be in at least one predetermined state when the circuit is actively operating. In some embodiments, the at least one predetermined state may refer to an ON state and an OFF state, where the states directly correlate with the device conducting current and/or allowing current to flow through it. In some embodiments, the Q3 112 may enable the operation of the circuit based on the at least one predetermined state associated with the Q3 112.

In some embodiments, the optional load R4 114 may connect the AC source to the input of the rectifier bridge. In some embodiment and in response to controlling the current in a particular manner, the optional load R4 114 may control the current of the circuit or device based on the connection between the AC source and the input of the rectifier bridge. In some embodiments, the circuit may be used to control the current flowing through the R4 114. In some embodiments, the circuit may be utilized to control the current sink from a power supply for at least one specific purpose, where the at least one specific purpose may refer to test leakage current, for example.

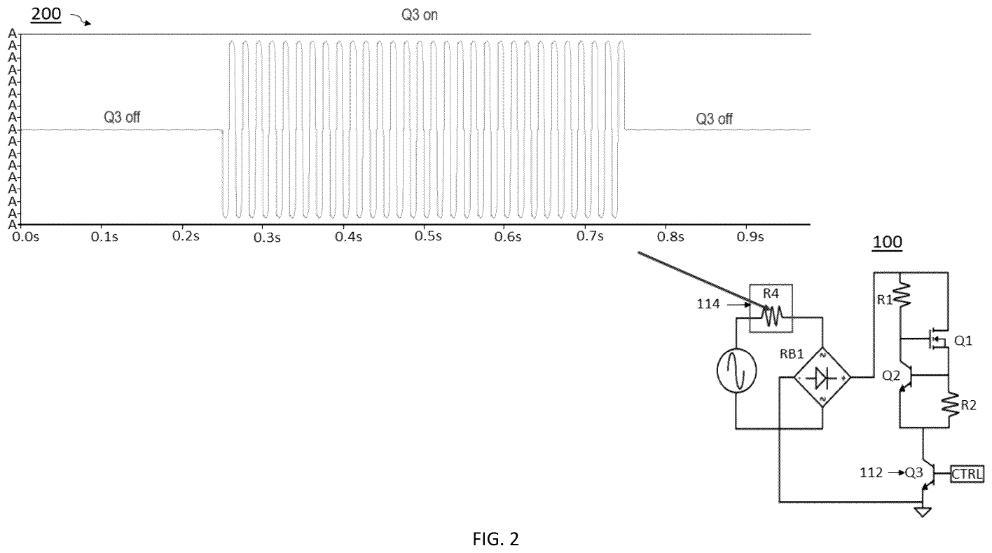

FIG. 2 depicts a first waveform graph 200 associated with the optional load R4 114 when Q3 112 switches between the at least two predetermined states. In FIG. 2, the current associated with the circuit measured at Q3 112 remains constant while the predetermined state associated with the Q3 112 is in the OFF state. In some embodiments, the y-axis of the waveform graph 200 may represents Amps, previously referred to as amperes, to measure the electrical current, specifically measuring the rate at which electric charge flows through the circuit. In some embodiments, the x-axis of the first waveform graph 200 may represent time in form of deci seconds. In FIG. 2 and in response to the Q3 112 switching to the ON state, the magnitude and frequency of the current is visible within the first waveform graph 200.

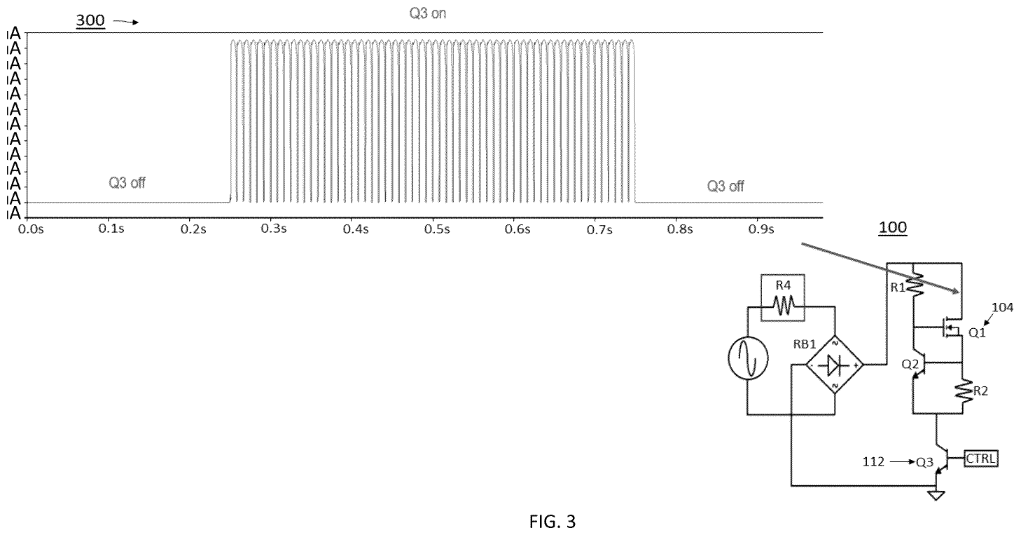

FIG. 3 depicts a second waveform graph 300 associated with the Q1 104 when Q3 112 switches between the at least two predetermined states. In FIG. 3, the current associated with the circuit measured at Q3 112 remains constant while the predetermined state associated with the Q3 112 is in the OFF state. In FIG. 3 and in response to the Q3 112 switching to the ON state, the magnitude and frequency of the current is visible within the second waveform graph 300 and the current flowing through the Q1 104 are more frequent than the current flowing through the R4 114 as seen in FIG. 2. In some embodiments, the constant current flowing through the Q3 112 within the second waveform graph 300 is a lower amp than the current flowing through the Q3 112 within the first waveform graph 200.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. An electrical circuit comprising:
an input terminal configured to receive a power signal as input;
a rectifier bridge configured to receive the power signal from the input terminal;
a resistive load connected between the input terminal and the rectifier bridge, the resistive load configured to control the current of the power signal to the rectifier bridge;
a current limiter circuit configured to receive a constant current from the rectifier bridge; and
an output terminal configured to provide an output power signal based on the constant current flowing through the current limiter circuit.

2. The electrical circuit of claim 1, wherein the rectifier bridge is configured to support at least twice a desired operating current value and twice a maximum input peak voltage.

3. The electrical circuit of claim 1, wherein the current limiter circuit comprises:
a metal-oxide-semiconductor-field-effect transistor (MOSFET), the MOSFET configured as a constant current source for the current limiter circuit;
a bipolar junction transistor (BJT), the BJT configured as a cut-off switch to adjust the MOSFET as a constant current driver for the current limiter circuit;
a first resistor, the first resistor configured as a bias resistor for the MOSFET and BJT;
a second resistor, the second resistor configured as a current resistor; and
an enable transistor.

4. The electrical circuit of claim 3, wherein the MOSFET, BJT and enable transistor are each configured to support at least twice a desired operating current value and twice a maximum input peak voltage.

5. An electrical apparatus comprising:
an input terminal configured to receive a power signal as input;
a rectifier bridge configured to receive the power signal from the input terminal;
a resistive load connected between the input terminal and the rectifier bridge, the resistive load configured to control the current of the power signal to the rectifier bridge;
a current limiter circuit configured to receive a constant current from the rectifier bridge; and
an output terminal configured to provide an output power signal based on the constant current flowing through the current limiter circuit.

6. The electrical apparatus of claim 5, wherein the rectifier bridge is configured to support at least twice a desired operating current value and twice a maximum input peak voltage.

7. The electrical apparatus of claim 5, wherein the current limiter circuit comprises:
a metal-oxide-semiconductor-field-effect transistor (MOSFET), the MOSFET configured as a constant current source for the current limiter circuit;
a bipolar junction transistor (BJT), the BJT configured as a cut-off switch to adjust the MOSFET as a constant current driver for the current limiter circuit;
a first resistor, the first resistor configured as a bias resistor for the MOSFET and BJT;
a second resistor, the second resistor configured as a current resistor; and
an enable transistor.

8. The electrical apparatus of claim 7, wherein the MOSFET, BJT and enable transistor are each configured to support at least twice a desired operating current value and twice a maximum input peak voltage.
